(19) United States
(12) Patent Application Publication
(10) Pub. No.: US 2014/0060981 A1
(43) Pub. Date: Mar. 6, 2014

(54) VEHICLE BRAKING SYSTEM

(71) Applicants: PETER BACK, Mannheim (DE); Harm_Hendrik Lange, Mannheim (DE); Hendrik Nordhoff, Stadtton (DE); Bernhard Knapp, Mannheim (DE)

(72) Inventors: PETER BACK, Mannheim (DE); Harm_Hendrik Lange, Mannheim (DE); Hendrik Nordhoff, Stadtton (DE); Bernhard Knapp, Mannheim (DE)

(21) Appl. No.: 13/599,586

(22) Filed: Aug. 30, 2012

(51) Int. Cl. F16D 65/76

(52) U.S. Cl. CPC F16D 65/76
USPC 188/72.1

(57) ABSTRACT

A vehicle braking system includes a wheel braking unit with an actuator, friction unit, and resilient member. The wheel braking unit is controlled by an operating element. The braking system can be operated in a normal operation mode by a control parameter. The braking system can be operated in a safety mode when the control parameter falls below a threshold value. In the normal mode, the control parameter acts on the actuator so that the actuator establishes a first air clearance in the friction unit. When in the safety mode, a resilient member establishes a second air clearance, which is smaller than the first air clearance.

### FIELD

The present disclosure relates to a braking system for a vehicle.

### BACKGROUND

A known vehicle braking system includes an operating element which controls a wheel braking unit. The wheel braking unit includes an actuator, a friction unit, and resilient member. The friction unit has an air clearance which must be overcome before it produces friction which brakes the wheel.

EP 2 146 109 A1 shows a disk braking system with a brake valve and a hydraulic retractor system, so as to maximize the air clearance in a normal operation mode and to make a manual braking effective in a safety mode. The retractor system includes a brake piston, a brake spring, and a retractor plunger. The retractor plunger is rigidly connected to the brake piston.

It is desired to have a braking system safety mode with a reduced air clearance, since the brake valve which controls the wheel braking system has available a reduced volume capacity in the safety mode. Thus, a better response behavior of the brake can be attained in the safety mode.

### SUMMARY

According to an aspect of the present disclosure, a braking system is provided with an improved control of the wheel braking system in the operation modes.

The vehicle braking system includes a wheel braking unit with an actuator, friction unit, and resilient member. An operating element controls the wheel braking unit, and the braking system is operated by a control parameter in a normal operation mode. When the control parameter falls short of a threshold value, the system operates in a safety mode. In the normal operation mode, the control parameter acts on the actuator so that the actuator establishes a first air clearance in the friction. In the safety mode, a resilient member establishes a second air clearance in the friction unit, which is smaller than the first air clearance, and wherein the control parameter can be overridden by a compensating element.

A friction unit may be, for example, a wheel shaft-rotating brake disk and a brake pad, fixed relative to a housing, which acts against the brake disk to bring about a friction contact. Alternatively, the friction unit may be a wheel shaft-rotating friction disk with friction pads and at least one contact element, which is fixed relative to the housing and acts against the friction disk. The contact element can be shaped as a round stop disk arranged concentrically, relative to the wheel shaft. Several resilient member are preferably arranged over the circumference, for example, three or four. The braking system can also be constructed as a drum brake, a shoe brake, or a cone brake.

An air clearance is an axial or radial gap, that is, axial or radial relative to the rotating axis of the braking system, between the elements of the friction unit, that is, between the brake disk and the brake pad or the friction disk and the contact element. The actuator exerts an adjustment effect on the friction unit to create an air clearance. A contrary effect, such as a restoring effect, is exerted by the resilient member on the friction unit.

With the braking system in the normal operation mode, a control of the wheel braking system or an action on the friction unit in the direction of a friction contact can be carried out, without the adjusting effect or the restoring effect of the actuator having to be overcome—that is, without this adjusting force having to be additionally applied. Rather, it is ensured that the control parameter, which triggers the restoring force, is overridden. This restoring force is the product of the pressure and piston areas with a hydraulic actuator, if the actuator is designed as a cylinder-piston unit, and with pressures of up to over 200 bar, can be significant with an agricultural utility vehicle. Furthermore, with the braking system in accordance with the invention, the advantage is to be found in the fact that with a reduced volume capacity of the operating elements in the safety mode as a result of the reduced air clearance, a safe braking can nevertheless take place with a rapid response.

Preferably, the compensating element for overriding the control parameter comprises spring elements. It is hereby advantageous if this arrangement is simply constructed and standard parts can be used.

In a first embodiment, the actuator can be connected via the spring elements to the friction unit to yield to tension and/or to pressure. In a second embodiment, the actuator can be connected via the spring elements to a housing of the wheel braking system to yield to tension and/or to pressure. The housing can be, for example, a brake caliper. With both designs, the simple structure with springs as standard parts is advantageous.

In another embodiment, the spring element can comprise a hydraulic storage unit. In this design, it is advantageous in that it makes minor demands on the need for space in the area of the brake, since the storage unit can be placed outside the housing of the wheel braking system.

The control parameter is preferably hydraulic oil pressure produced by an oil pump. Advantageously, oil pressure is available for the normal operation mode, independently of an operation of the braking system.

In another preferred design, a pressure storage unit, in which the hydraulic oil pressure can be stored, is provided. In this way, a pressure supply, independent of an oil pressure source, is advantageously guaranteed over a specific period of time. Alternatively, instead of hydraulics, pneumatics can also be provided.

In another preferred design, the operating elements comprise a hydraulic brake valve. In particular, it is preferred to have a check valve between the oil pump and the operating element, or between the oil pump and the hydraulic brake valve in a supply line.

In a first embodiment, the pressure storage device is located between the check valve and the brake valve, and the pressure storage unit is connected in series in a hydraulic connection line between the check valve and the brake valve.

Preferably, in the first embodiment, the control parameter for the actuator is measured or sensed between the pressure storage unit and the hydraulic brake valve. In the first embodiment, it is advantageous that after a failure of the oil pump, hydraulic pressure in the hydraulic line to the actuator continues to be present.

In a second embodiment, the pressure storage unit branches off between the check valve and the hydraulic braking valve. The pressure is sensed between the check valve and the oil pump. In the second embodiment, it is advantageous that after a failure of the oil pump, the actuator is no longer supplied with the hydraulic pressure via the hydraulic line, so that after the readings fall short of the threshold values of the control parameter, the braking system is in the safety mode, whereas the pressure storage unit still provides, as in the normal operation mode, for a certain number of brakings with oil pressure, which can be designated as an overlapping.

Preferably, the actuator is a hydraulic cylinder-piston unit. The actuator is connected to the operating element by a hydraulic line.

For all embodiments, it is preferable that branch line connects the hydraulic line to a hydraulic reservoir for relieving the hydraulic pressure during the change from the normal operation mode to the safety mode. This ensures that with a failure of the pressure supply, for example, by the oil pump, the hydraulic pressure in the hydraulic line is reduced, so that the braking system is in the safety mode. Furthermore, it is preferred that at least one throttle valve be located in the hydraulic line, wherein in particular, it is preferable that at least one throttle valve be located before the branch to the hydraulic reservoir and one throttle valve, after the branch to the hydraulic reservoir. This advantageously guarantees that an oil flow into the hydraulic reservoir is limited to a defined value. Furthermore, one can adjust the pressure decline over time with a lack of or failure of the pressure supply, by coordination with the throttle valve. In another preferred embodiment, two resistance-equivalent throttle valves or orifices connected in series can be provided. In this way, a clogging of the throttle valve after the branch can be avoided.

Preferably, the wheel braking unit has a second actuator—in particular, a cylinder-piston unit—which places the friction unit into a friction contact or frictional locking in the normal operation mode, and in the safety mode, after exerting control through the operating elements. The second actuator is preferably controlled by the control parameter.

For all embodiments, it is also preferable if the brake valve, the check valve, and the control parameter sensor for the actuator are designed so they can be integrated in the structure, preferably within a housing. The sensing of the pressure storage unit is also preferably integrated. This guarantees that the risk of a line buckling is reduced and different supply or signal statuses can be present for the brake valve and the first actuator and the second actuator.

### BRIEF DESCRIPTION OF THE DRAWINGS

FIG. 1 is a schematic diagram of a braking system in accordance with the invention in a first embodiment, with a first variant of a first actuator;

FIG. 2a is a schematic diagram of the brake system of FIG. 1 with a second variant of a first actuator;

FIG. 2b is a schematic diagram of the brake system of FIG. 1 with a third variant of a first actuator; and

FIG. 3 is a schematic diagram of a second embodiment of the brake system of FIG. 1.

### DETAILED DESCRIPTION OF THE DRAWINGS

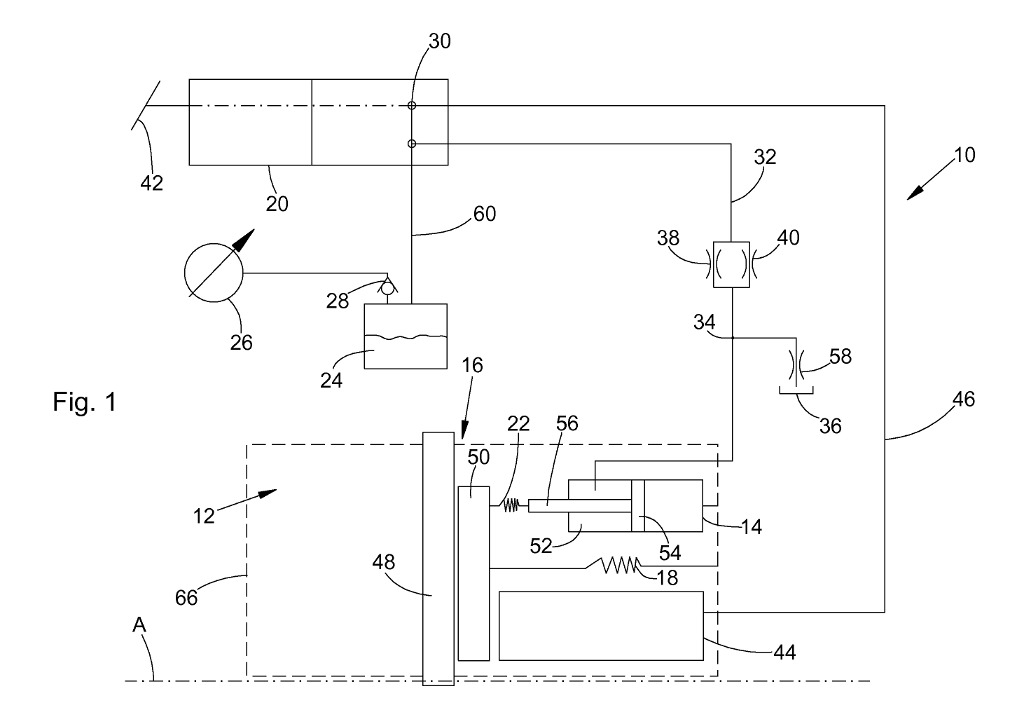

Referring to FIG. 1, a braking system 10 has an oil pump 26 and a pressure storage unit 24, via which a control parameter can be created in the form of a hydraulic oil pressure. The braking system 10 also includes an operating element 20 with a brake pedal 42, which can be operated by an operator, to act on a brake valve 30 and a wheel braking unit 12. The operating elements 20 and the wheel braking unit 12 are connected hydraulically to one another via a first hydraulic line 32 and a second hydraulic line 46.

A branch line 34 connects the first hydraulic line 32 to a hydraulic oil reservoir 36. A first throttle valve 38 and a second throttle valve 40 are arranged parallel to one another, upstream from this branch 34. A third throttle valve 58 is located downstream from the branch line 34. The function of this arrangement is described further below.

The wheel braking unit 12 includes a first actuator 14 in the form of a first cylinder-piston unit, a second actuator 44 in the form of a second cylinder-piston unit, and a friction unit 16, which includes a friction disk 48 with friction linings and a stop disk 50. The friction disk 48 rotates around a rotation axis A and the stop disk 50 and the actuators 14, 44 are mounted so they cannot rotate. The stop disk 50 can move axially with respect to the axis A. Alternatively, the friction unit 16 may include a brake disk and a brake pad.

Furthermore, a resilient member 18 is provided in the form of a coiled helical compression spring, wherein in principle, other spring types may also be appropriate. The resilient member 18 is supported on one side (not shown) on a housing 66 of the wheel braking unit 12. The housing 66 may be an annular housing in a typical design, or alternatively, a brake caliper. On the other side, the resilient member 18 is coupled to the stop disk 50. The resilient member 18 is positioned between the housing 66 and the stop disk 50 and is biased to urge the stop disk 50 towards the friction disk 48. In this way, at least one placement of the stop disk 50 against the friction disk 48 is attained.

Furthermore, a compensating element 22, in the form of a compression spring, is located between the first actuator 14 and the stop disk 50. In this way, the first actuator 14 and the stop disk 50 are connected to one another, so they can move relative to one another or yield to tension. The function of the relative movement between the first actuator 14 and the stop disk 50 is described further below.

During a normal operational mode of the braking system 10, a combustion engine (not shown) of an agricultural utility vehicle drives the pump 26 which produces a hydraulic pressure in the braking system 10, which is stored in the pressure storage unit 24. With regard to the normal operation mode, a distinction between a braked status and an un-braked status must be made.

When an operator actuates the operating elements 20 via the brake pedal 42, the braked status of the normal operation mode is introduced. By actuating the brake pedal 42, the brake valve 30 is opened by a corresponding amount, so that a volume of pressurized hydraulic oil is communicated to the second actuator 44, through the second hydraulic line 46. In this way, the stop plate 50 is moved towards the friction disk 48 by the second actuator 44 in the normal operation mode, and friction contact occurs in the friction unit 16. Before the actuation, an air clearance or space separates the stop plate 50 from the friction plate 48, which must be overcome before the stop disk 50 engages the friction plate 48. The air clearance can be between 0.5 mm and 1.5 mm in the un-braked status of the normal operation mode, and is preferably approximately 1 mm.

In the embodiment of the first actuator 14 of FIG. 1, the air clearance is established as follows. Via the hydraulic line 32, the pressure chamber 52 of the first actuator 14 is provided with hydraulic pressure, so that the piston 54 and the tension rod 56 coupled with it move away from the friction disk 48 with the screw tension spring 22 and the stop disk 50. By this movement, the resilient member 18 is compressed. The spring constants of the resilient member 18 and the compensating element 22 are coordinated with one another so that the spring constant of the compensating element 22 or the total spring constant of several (not shown) compensating elements is higher than those of the resilient member 18, so that with the adjustment movement of the air clearance, the compression spring 18 is compressed without the compensating element 22 being equally deflected.

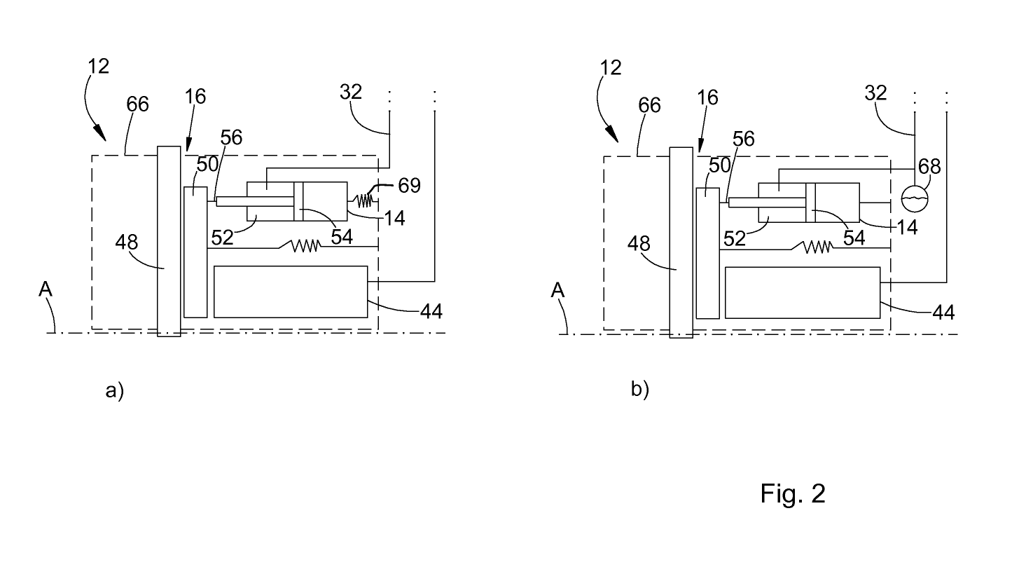

FIGS. 2a and 2b show alternative embodiments of the first actuator 14. With the alternative of FIG. 2a, a compensating element 64 in the form of a coil tension spring is located between the first actuator 14 and the housing 66 of the wheel braking unit 12. The first actuator 14 can be moved parallel to the rotating axis A in the housing 66, in a manner that is not depicted in more detail. With the alternative embodiment of FIG. 2b, a compensating element 68 in the form of a hydraulic spring assembly is connected to the hydraulic line 32. With these alternative embodiments also, the spring constants of the compensating elements 64 and 68 are designed so that they are higher than the spring constant of the resilient member 18.

With the three described embodiments of the first actuator, the compensating elements 22, 64, and 68 are respectively used to override an actuation of the brake by the second actuator 44. The function of the compensating elements 22, 64, 68 is decisive for the transition from the un-braked status to the braked status of the normal operation mode. As described above, the second actuator 44 moves the stop disk 50 against the friction disk 48 or towards the friction disk 48 upon actuation of the brake pedal 42. The individual compensating element 22, 64, 68 makes possible hereby a relative movement between the stop disk 50 and the first actuator 14, which, as described above, moves the stop disk 50 from the friction disk 48 because of the hydraulic pressure for the adjustment of the air clearance. In the braked status of the normal operation mode, therefore, the second actuator 44 and the parallel spring force of the resilient member 18 overcome the spring force of the individual compensating element 22, 64, 68, so that it is deflected, and the first actuator 14, in fact, experiences no or almost no movement. Since in this status the control parameter also acts on the first actuator 14, the control parameter is overridden by the individual compensating element 22, 64, 68.

The transition from the normal operation mode to the safety mode takes place if hydraulic oil pressure is no longer available or there is insufficient hydraulic oil pressure. This can be the case, for example, if the oil pump 26 has broken down or there is a leakage or a buckling or a compression of a hydraulic line. In such a case, the hydraulic pressure in the hydraulic line 32 is reduced to such an extent that oil flows into the hydraulic oil reservoir 36, via the branch 34, through the throttle valve 24. If the hydraulic pressure in the first actuator 14 falls short by a certain extent, so that the force of the actuation on the stop disk 50 falls short of the restoring force of the resilient member 18 on the stop disk 50, the stop disk 50 is acted on by the resilient member 18 against the friction disk 48, so that the air clearance is at least almost eliminated. Provision can also be made so that after the elimination of the air clearance, a certain braking effect is already attained. In this state, the braking system 10 is in the safety mode, in which in a known manner, the operator can produce a hydraulic pressure in the hydraulic line 46—with reduced volume capacity of the brake valve 30, by means of the brake pedal 42 and via the brake valve 30, in order to move the stop disk 50 against the friction disk 48 via the second actuator 44, and to produce a friction locking. Thus, when operating the braking system 10 in the safety mode, an air clearance, or at least only a minimal air clearance, need not be overcome, before a frictional engagement between the stop disk 50 and the friction disk 48, is developed.

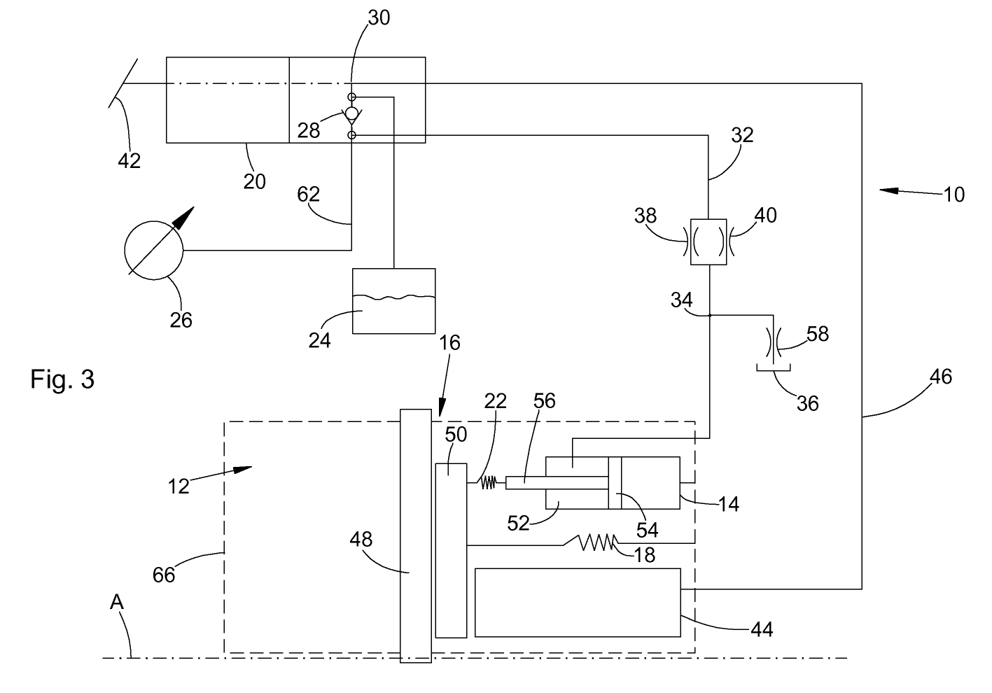

The difference between the embodiment of FIG. 1 and that of FIG. 3 is described below, wherein for reasons of simplicity, the first variant of the first actuator 14 with the compensating element 22 is shown in both embodiments. With both embodiments of the braking system 10, one of the three alternative embodiments of the first actuator 14 can be used.

In the embodiment of FIG. 1, the oil pump 26 supplies the pressure storage unit 24 with oil pressure via the check valve 28. The pressure storage unit 24 is connected to the brake valve 30 via the hydraulic line 60. From the hydraulic line 60, the hydraulic line 32 branches off as a control line or pilot line to supply the first actuator 14 in the form of the first cylinder-piston unit. Preferably, the branch of the hydraulic line 32 from the hydraulic line 60 is structurally integrated into a housing of the operating elements 20. If the oil supply fails in this first embodiment example, for example, if the oil pump 26 is no longer driven, the braking system 10 falls first into the safety mode, if the oil pressure in the pressure storage unit 24 has declined so much due to relief of the hydraulic line 32 into the hydraulic oil reservoir 36 or by the brake actuation that the hydraulic pressure in the first actuator 14 falls short by a certain extent so that the force of the actuation on the stop disk 50 falls short of the restoring force of the resilient member 18 on the stop disk 50, as described above.

In the second embodiment of FIG. 3, the oil pump 26 also supplies the pressure storage unit 24 with oil pressure via a check valve 28. However, the hydraulic line 32 branches off as a control line or pilot line from a hydraulic line 62 between the oil pump 26 and the check valve 28. Preferably, the branch of the hydraulic line 32 from the hydraulic line 62 and the check valve 28 is structurally integrated into a housing of the operating elements 20. If the oil supply fails in this second embodiment, for example, if the oil pump 26 is no longer driven, then the braking system 10 falls into the safety mode, if the oil pressure in the hydraulic line 32 has declined due to relief into the hydraulic oil reservoir 36, to such an extent that the hydraulic pressure in the first actuator 14 falls short by a certain extent, so that the force of the actuation on the stop disk 50 falls short of the restoring force of the resilient member 18 on the stop disk 50, as described above. In the second embodiment, the oil pressure in the pressure storage unit 24, therefore, need not first be raised. Thus, the braking system 10 of the second embodiment falls more quickly into the safety mode than the braking system 10 according to the first embodiment in case of discontinuation of the pressure supply. After a change of the braking system 10 to the safety mode, a different pedal feeling compared with an operation of a braking system 10 in accordance with the first embodiment is produced for the operator who operates a braking system 10 in accordance with the second embodiment. Essentially, the different pedal feeling is determined by a greater pedal path, since the oil volume in the brake valve 30 required for the filling of the wheel-side brake piston is limited. The pedal feeling of the first embodiment is determined in that the normal operation mode is maintained up to a pressure decline in the pressure storage unit 24. Until then, the operator accordingly experiences an unchanged pedal feeling and afterwards, the pedal feeling is determined by the safety mode in which the operator must raise the hydraulic oil pressure and the oil volume for the second actuator 44 by means of the brake pedal 42 via the brake valve 30.

The pedal feeling of the second embodiment is determined in that as a result of the failure of the pressure supply, the braking system 10 has fallen into the safety mode, that is, the first actuator 14 does not maintain an air clearance; the second actuator 44, however, is supplied with oil pressure from the pressure storage unit 24 for a certain number of brakings via an actuation of the brake valve 30 by means of the brake pedal 42. Thus, with a normal braking by means of the still existing oil pressure from the pressure storage unit 24, an air clearance need not be first overcome before the friction unit 16 is brought into a friction locking.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

We claim:

1. A vehicle braking system, having an operating element which controls a wheel braking unit, the wheel braking unit having an actuator, a friction unit, and resilient member, the braking system being operated by a control parameter in a normal operation mode, and the braking system being operable in a safety mode when the control parameter falls short of a threshold value, wherein in the normal operation mode, the control parameter acts on the actuator so that the actuator establishes a first air clearance in the friction unit and wherein, in the safety mode, the resilient member establishes a second air clearance, which is smaller than the first air clearance, characterized in that:
a compensating element is operable to override the control parameter.

2. The braking system of claim 1, wherein:
the compensating element comprises a spring element.

3. The braking system of claim 2, wherein:
the actuator is connected via the spring element to the friction unit.

4. The braking system of claim 2, wherein:
the actuator is connected via the spring element to a housing (of the wheel braking system.

5. The braking system of claim 2, wherein:
the spring element comprises a hydraulic storage unit.

6. The braking system of claim 1, wherein:
the control parameter is a hydraulic oil pressure produced by an oil pump, and stored in a pressure storage unit.

7. The braking system of claim 1, wherein:
the operating element comprises a hydraulic brake valve.

8. The braking system of claim 6, wherein:
a check valve is located between the oil pump and the operating element.

9. The braking system of claim 8, wherein:
the pressure storage unit is located between the check valve and the brake valve.

10. The braking system of claim 9, further comprising:
a pressure sensor for sensing hydraulic pressure between the pressure storage unit and the hydraulic brake valve.

11. The braking system of claim 9, wherein:
control parameter for the actuator is measured between the check valve and the oil pump.

12. The braking system of claim 6, wherein:
the actuator is a hydraulic cylinder-piston unit which is connected to a hydraulic line.

13. The braking system of claim 12, wherein:
a branch line connects the hydraulic line to a hydraulic oil reservoir to relieve hydraulic pressure when the normal operation mode changes to the safety mode.

14. The braking system of claim 12, wherein:
a throttle valve is located in the hydraulic line.

15. The braking system of claim 12, wherein:
an orifice is located in the hydraulic line.
